(19) United States
(12) Patent Application Publication
(10) Pub. No.: US 2018/0034033 A1
(43) Pub. Date: Feb. 1, 2018

(54) DESIGN FOR SOLID CELLS

(71) Applicant: Robert Bosch GmbH, Stuttgart (DE)

(72) Inventors: Reiner Ramsayer, Rutesheim (DE); Ingo Kerkamm, Stuttgart-Rohr (DE); Markus Kohlberger, Stuttgart (DE)

(73) Assignee: Robert Bosch GmbH, Stuttgart (DE)

(21) Appl. No.: 15/549,633

(22) PCT Filed: Jan. 18, 2016
(86) PCT No.: PCT/EP2016/050879

§ 371 Date: Aug. 8, 2017

(30) Foreign Application Priority Data
Feb. 10, 2015 (DE) 10 2015 202 338.9

(51) Int. Cl. H01M 2/26; H01M 10/0525; H01M 10/0585

(52) U.S. Cl. CPC H01M 2/266; H01M 10/0585; H01M 10/0525

(57) ABSTRACT

The invention relates to a method for producing a solid cell, in particular a lithium-ion solid cell, having at least one cell layer (1) with a first conductor layer (2) and a second conductor layer (3) and at least one partition layer, wherein the first conductor layer (2) and the second conductor layer (3) are each electrically connected to a current discharge conductor (4, 5) and/or in each case one current discharge conductor (4, 5) is formed from the first conductor layer (2) and/or the second conductor layer (3). According to the invention, it is provided that the cell layer (1) has a plane of symmetry (SE) with an axis of symmetry (AA), wherein the plane of symmetry (SE) is constructed symmetrically in relation to the axis of symmetry (AA), and in that the current discharge conductors (4, 5) are arranged symmetrically in relation to the axis of symmetry (AA) and are routed out of the cell layer (1) on at least one side by means of the plane of symmetry (SE).

### BACKGROUND OF THE INVENTION

The invention relates to a method for producing a solid-state cell and also a solid state cell.

Solid-state cells or solid-state or solid-body batteries are currently of particular interest both for mobile and also for stationary applications. In the case of these cells, liquid electrolytes are replaced by solid-state electrolytes. As a consequence, it is possible by way of example to reduce the risk of a thermal runaway/fire and also to reduce the risk of the solid-state cell exploding and in so doing to increase the safety and cycle stability of the battery.

However, owing to their internal construction and the manner in which they function, namely by storing and discharging lithium, the solid-state cells, by way of example solid-state lithium ion batteries, expand or shrink to a greater extent as the cell is charged or discharged in comparison to known lithium ion cells that have liquid electrolytes. The extent of the expansion or shrinkage can be in the range of 10 to 40% expansion or shrinkage depending upon the cell construction.

In the simplest case, such a solid-state cell comprises at least one cell layer having a first conductive layer and a second conductive layer that are separated at least by means of a separating layer. In particular, the solid-state electrolyte can be embodied from a ceramic composite or from a glass-ceramic composite. In addition, it is known to separate the anode and the cathode from the electrolytes by means of the separating layer that comprises by way of example a polymer-ceramic composite. By virtue of the separating layer, also called a separator layer or separator, the charge transfer at the anode is improved and the cathode is connected in an electro-chemical manner to the electrolytes. In addition, the separator is used so as to reduce the electrical resistance. The conductive layers, namely the anode and the cathode, which are also described as current collectors or anode current collectors or cathode current collectors, are typically produced from a thin sheet. The anode can for its part be by way of example a copper of nickel sheet, the cathode for its part can be an aluminum sheet as is usual in the case of the conductive layer.

In order to adjust the solid-state cell to suit its requirements, namely to increase the voltage, current strength or capacity, it is known to stack multiple cell layers in a layer stack. In so doing, it is necessary to connect the cell layers in the layer stack and in so doing it is necessary in particular to connect the layers that comprise current collectors, solid-state electrolytes and separators.

Typical connection arrangements are parallel connections or series or row connections of the cell layers in the layer stack or multiple layer stacks with one another. So as to increase the voltage, current strength or capacity of prismatic lithium ion cells, it is also known to connect the cell wrap in parallel or in series within the prismatic solid-state cell.

However, in the case of the known solid-state cells, the parallel or series connection is extremely complex and consequently the production is cost intensive owing to the geometry and design of the cell layers or of the layer stack and in particular owing to the arrangement of the current collectors. In addition, the known connection variants require a large amount of installation space that must be further increased in order to ensure the 10 to 40% expansion or shrinkage of the cell layers or of the layer stack within the solid-state cell.

### SUMMARY OF THE INVENTION

It is therefore the object of the invention to overcome at least in part the disadvantages known from the prior art. In particular, it is the object of the present invention to simplify the connection arrangement of the cell layers or of the layer stack whilst exploiting the advantages of the solid-state cells, cell stack or pouch cells.

So as to achieve the object, a method is proposed for producing a solid-state cell in particular a lithium ion solid-state cell. The object is further achieved by means of a solid-state cell in particular a lithium ion solid-state cell.

In so doing, features and details that are described in connection with the method in accordance with the invention naturally also apply in connection with the solid-state cell in accordance with the invention and in each case conversely so that with regard to the disclosure reference is continuously being made or can be made in an alternating manner to the individual aspects of the invention.

The method in accordance with the invention for producing a solid-state cell, in particular a lithium ion solid-state cell, comprising at least one cell layer having a first conductive layer and a second conductive layer and at least one separating layer, wherein in each case the first conductive layer and the second conductive layer are connected in an electric manner to a current collector and/or a current collector is embodied in each case from the conductive layer and/or from the second conductive layer, the technical doctrine includes that the cell layer comprises a plane of symmetry that has an axis of symmetry, wherein the plane of symmetry is constructed in a symmetrical manner with respect to the axis of symmetry, and that the current conductor is arranged in a symmetrical manner with respect to the axis of symmetry and is guided over and beyond the plane of symmetry on at least one side out of the cell layer.

It is preferred that a solid-state battery or a solid-state accumulator (i.e. a rechargeable battery) is to be understood as a solid-state cell. In the case of a lithium ion battery, the solid-state cell comprises an anode in particular in the form of a lithium layer, an electrolyte layer that comprises either a ceramic or is embodied from glass or however from a ceramic composite, and also a cathode that comprises a porous carbon layer. In the case of this construction, the anode and the cathode are generally separated from the electrolytes by means of a separator layer (separator) that comprises by way of example a polymer ceramic composite. By means of the separator, the charge transfer at the anode is improved and the cathode is connected in an electro-chemical manner to the electrolyte. Furthermore, the separator is also used so as to reduce the electrical resistance.

The conductive layers of the anode and of the cathode that are connected to a current collector or from which it is possible to embody an anode current collector or a cathode current collector are advantageously produced from a thin sheet. With regard to the anode, said sheet is advantageously by way of example a copper sheet or nickel sheet. With regard to the cathode, the conductive layer preferably in the form of an aluminum sheet.

In contrast to the known solid-state or solid-body cells, the cell layer comprises in accordance with the invention an (imaginary) plane of symmetry having an axis of symmetry and said cell layer comprises at least on the cathode side a cathode conductive layer (first conductive layer) and on the anode side an anode conductive layer (second conductive layer). Since the plane of symmetry is constructed in a symmetrical manner with respect to the axis of symmetry, the conductive layers, namely the cathode conductive layer and the anode conductive layer or the current collector that is embodied therefrom, are arranged in a symmetrical manner with respect to the axis of symmetry. Owing to the symmetrical construction of the cell layer and the symmetrical arrangement of the current collector, the cell layers or the layer stack that is constructed therefrom in a symmetrical manner or the cell layer plane stack (hereinunder also referred to as the layer stack) can be connected in a simple manner parallel and/or in series with one another by means of connecting the current collector. The symmetrical design of the cell layers or of the layer stack and the symmetrical arrangement of the current collectors that are guided over and beyond the plane of symmetry on at least one side out of the cell layer simplifies also the design of a current rail or of a current collector by way of which the cell layers or also the layer stack are connected to one another in parallel and/or in series and are connected in an electric manner. This renders it possible to minimize (possibly even completely minimize) the connection distance for connecting the current collector. The current rail or the current collector can be used advantageously as an outlet to a consumer. Since the current collectors, which are connected in each case in an electrical manner to the conductive layers, or the current collectors that are formed from the conductive layers, are embodied in an advantageous manner from a very thin sheet, the current collectors of the cell layer or of the layer stack are preferably connected to one another in an electric manner or are connected to the current collector advantageously by means of bonding or by means of ultrasound welding so as to form a parallel and/or series connection of the cell layers or layer stack. The electrical connection is advantageously produced by means of an overlap.

Since in the case of producing in accordance with the invention the solid-state cell, the cell layer or the layer stack comprises a plane of symmetry that is constructed in a symmetrical manner with respect to an axis of symmetry, it is preferred that the cell format of the solid-state cell or of the cell layer or of the layer stack has a rectangular, square or circular shape. In the case of rectangular or square-shaped cell layers or layer stacks, it is possible to considerably increase the power density of the solid-state cell. The cell format of the solid-state cell or of the cell layer or of the layer stack can furthermore have any shape in which a plane of symmetry comprises an axis of symmetry, wherein the plane of symmetry is constructed in a symmetrical manner with respect to the axis of symmetry. Accordingly, the side of the cell layer or of the layer stack on which the current collector is guided over and beyond the plane of symmetry out of the cell layer can be embodied in a linear and/or circular manner.

In order to facilitate the series or parallel connection of the cell layers or of the layer stack, it is preferred to guide one current collector on one side of the cell layer or of the layer stack and to guide the other current collector on another in particular adjacent side of the cell layer out of the layer stack out of the cell layer. If it is intended by way of example to connect multiple cell layers parallel to one another in a layer stack, wherein a current rail or a current collector is preferably used, it is possible to arrange on one side of the cell layers of the layer stack all current collectors that are guided from the anode conductive layer over and beyond the plane of symmetry out of the cell layers so that when viewing the layer stack from above said current collectors lie one above the other in an at least approximately congruent manner on one side of the layer stack. The current collectors of the cathode conductive layer are then advantageously guided on another side of the cell layers or of the layer stack over and beyond the plane of symmetry out of the cell layer or of the layer stack. In particular, this renders possible this geometric arrangement of the current collectors on at least two sides of the cell layer or of the layer stack. In particular, a suitable design for a current collector is one that is guided on two different and in particular on four different sides over and beyond the plane of symmetry out of the cell layers if the anode conductive layer and the cathode conductive layer are a continuous layer or as flexible tracks into which the cell layers of the layer stack are inlaid. In the case of this design of a layer stack having multiple cell layers, the cell layers that are embodied from a continuous layer connect to one another in an electrical manner the conductive layers of the cell layers that are stacked in the layer stack.

During the procedure of inlaying the flexible track that is advantageously layered as a continuous layer in the layer stack of the solid-state cell, deflections are formed between the conductive layers of cell layers that are connected to one another in an electrical manner within a layer stack. These deflections encompass in each case the layers of the layer stack that are layered between two layers of a conductive layer.

In an advantageous manner, the deflections are used as current collectors, wherein the current collectors are embodied from the first conductive layer and/or the second conductive layer, and wherein by way of the current collector the cell layers of a layer stack or multiple layer stacks of a solid-state cell can be advantageously connected in parallel or in series to one another in an electric manner. The current collector that is formed from the conductive layer can however also be formed within a cell layer module, namely a cell layer, as a current collector from the anode conductive layer or from the cathode conductive layer. In both cases, the current collector is embodied from the sheet material of the anode conductive layer and the cathode conductive layer.

If at least two cell layers are arranged to form a layer stack, the two cell layers are advantageously arranged with respect to one another in such a manner that they jointly form a plane of symmetry. On the basis of the jointly formed plane of symmetry and on the proviso that the current collectors of the two cell layers are guided to the same sides, when viewing the layer stack from above the current collectors of the two cell layers are arranged in the layer stack one above the other in a congruent manner as a result of the jointly formed plane of symmetry that is also arranged as the current collector in a symmetrical manner with respect to the axis of symmetry.

If it is desired to guide the current collectors over and beyond the plane of symmetry out of the cell layers in an alternating manner, in other words changing between multiple sides of the layer stack, it is advantageous if at least one cell layer is rotated, with respect to the other cell layer, said cell layers forming with one another the layer stack, about an axis of symmetry that extends centrally through the plane of symmetry and lies in an orthogonal manner with respect to the plane of symmetry, as a consequence of which the cell layers are connected in a series and/or parallel manner by way of the current collectors. By virtue of rotating the cell layers about the axis of symmetry that is lying in an orthogonal manner with respect to the plane of symmetry, it is possible by way of example to arrange the cathode current collector of a first cell layer on one side and advantageously at least approximately in a congruent manner with an anode current collector of a second cell layer, wherein in this case the layer stack is considered when viewing the plane of symmetry from above so that the cell layers in the cell stack can be connected to one another in series by way of example by a current collector on one side of the layer stack. A layer stack that is constructed in such a manner and is formed by means of cell layers that are rotated about an axis of symmetry that is lying in an orthogonal manner through the plane of symmetry can also be connected in a simple manner to a layer stack that is constructed in an identical manner thereto within a solid-state cell by means of connecting the current collectors of one layer stack to the current collectors or the other layer stack.

In an advantageous manner, the cell layers and consequently also the first current conductor are rotated with respect to the second current collector, which are guided over and beyond the plane of symmetry out of the cell layers, by at least 90° about the axis of symmetry that extends in an orthogonal manner through the plane of symmetry. In general, it is possible to rotate the cell layers within the layer stack in a rotation range of 0° to 360° about the axis of symmetry that extends in an orthogonal manner through the plane of symmetry. The rotation of the cell layers about the axis of symmetry is also used in an advantageous manner so as by way of example to arrange or lay current collectors in a congruent manner one above the other, said current collectors being guided on one side of the layer stack out of the cell layers.

In order to achieve a particularly advantageous connection-friendly design of the cell layers, it is advantageous if the current collectors are guided in a symmetrical manner, in other words in particular centrally on the side out of the cell layer. When layered one above the other to form layer stacks, the current collectors that are guided outwards on the sides then lie at 90°, 180° or 270° with respect to one another in the cell stack. In addition, the symmetrical arrangement of the current collectors renders it possible for the current collectors that lie above or below one another to be arranged in at least an approximately completely congruent manner, said current collectors being guided centrally on the side over and beyond the plane of symmetry out of the cell layers.

It is possible in an advantageous manner to connect in one plane, in other words in the same plane, two or multiple cell layers in series and/or in parallel by way of the current collectors that are guided over and beyond the plane of symmetry out of the cell layers, as a result of which it is possible to produce a solid-state cell with a particularly flat design but with increased voltage and current strength/capacity. In so doing, as a result of the symmetry of the cell layers it is advantageously possible to arrange the current collectors in a variable manner with respect to one another and this renders it possible to connect the cell layers in series and/or in parallel in one plane in a simple manner. It is naturally also feasible to further guide the cell layers that are connected in one plane into another plane that lies below or above said plane, namely to connect in parallel or in series the cell layers, which are connected in one plane, to one or multiple cell layers that lie above said layer. This type of connection over at least two planes is intended to be understood in terms of the present invention as a layer or plane step. It is naturally possible for the cell layers that are thus connected out of one plane into the next plane and form jointly a layer stack to be connected to a further layer stack in parallel and/or in series.

If four cell layers in one plane are preferably connected to one another, wherein by way of example two cell layers are connected in parallel and two cell layers are connected in series thereto, it is possible in an advantageous manner to use the installation space between the cell layers for arranging the current collectors within this installation space and to connect said current collectors in an electrical manner to the current collector of the cathode conductive layer and the current collector of the anode conductive layer.

The connection of multiple cell layers in one plane, in parallel and/or in a series connection, by way of current collectors, contact sites and/or by way of the current collector to other cell layers that lie in lower or upper planes, renders possible flexible connection variants within a layer stack that is formed over multiple planes from cell layers that are connected one to the other. In addition, this connection of multiple cell layers in one plane, said cell layers being connected by way of a layer step to other cell layers in planes that lie above or below said plane has the advantageous effect that the expansion or the shrinkage as the solid-state cell is charged or discharged has only a very small effect on the contact sites between the individual cell layers, wherein the contact sites are embodied in an advantageous manner by means of the current collectors that are formed from the conductive layers.

Particularly advantageous is a double-symmetrical design of the cell layer, namely with the plane of symmetry that is constructed in a symmetrical manner with respect to the axis of symmetry, and the current collector that is guided in a symmetrical manner in other words in particular centrally to the side over and beyond the plane of symmetry out of the cell layer. It is possible by virtue of this design of the cell layer to rotate the cell layer not only between 0 and 360° about the axis of symmetry that lies in an orthogonal manner with respect to the plane of symmetry but rather in an advantageous manner the cell layer can be mirrored by way of the axis of symmetry that extends through the plane of symmetry. As a consequence, the accessibility of the contact joining sites, in other words the accessibility of the contact lugs or current collectors that are formed from the conductive layers, is advantageously simplified. If it is desired to connect in series or in a row the cell layers that are embodied in this manner within a layer stack, it is sufficient to rotate the cell layers by 90° about the axis of symmetry that extends in an orthogonal manner through the plane of symmetry. By virtue of additionally mirroring the cell layer over and beyond the plane of symmetry, it is in addition possible in an advantageous manner to alternate between a series connection and parallel connection by way of example within one layer stack or in one plane. The double-symmetrical design of the cell layer renders it possible in an advantageous manner to achieve a very flexible design of both the cell layers that are connected to one another on one plane and also the cell layers that are connected to one another in a layer stack.

The object of the present invention is likewise achieved by means of a solid-state cell, in particular a lithium ion solid-state cell that is produced in particular according to the method in accordance with the invention, said solid-state cell having a first conductive layer and a second conductive layer and at least one separating layer, wherein in each case the first conductive layer and the second conductive layer is connected in an electrical manner to a current collector and/or in each case a current collector is embodied from the first conductive layer and/or the second conductive layer. In the case of the solid-state cell, it is provided in accordance with the invention that the first conductive layer, the second conductive layer and the separating layer are arranged with respect to one another in such a manner that at least one plane of symmetry is formed that comprises an axis of symmetry, wherein the plane of symmetry is constructed in a symmetrical manner with respect to the axis of symmetry and that the current collectors are arranged in a symmetrical manner with respect to the axis of symmetry and are guided over and beyond the plane of symmetry on at least one side out of the cell layer.

The solid-state cell in accordance with the invention can be embodied from only one cell layer that is embodied in a symmetrical manner as described. However, in an advantageous manner, the solid-state cell in accordance with the invention comprises at least two cell layers and/or two layer stacks or cell layer plane stacks that are connected to one another in an electrical manner by way of the current collectors. The two cell layers can lie advantageously in one plane or can be stacked one above the other to form a layer stack. The layer stacks can advantageously comprise multiple cell layers that are stacked one above the other and are connected to one another in an electrical manner. The layer stacks can however also comprise multiple cell layers that are connected to one another in one plane and are connected by way of a layer step to a next cell layer or cell layer plane that lies in a lower or an upper plane, wherein the multiple planes that are thus formed are understood in terms of the present invention as a cell layer plane stack.

Within the solid-state cell, it is possible for the cell layers, the layer stack and the cell layers that form the layer stack or are connected to one another in one plane to be connected both in parallel and also in series to one another. The type of connection within the solid-state cell can be changed in a flexible manner or the type of connection can be alternated within the cell layer, the cell layers that are to be connected to one another in one plane or multiple planes or between at least two layer stacks in a variable manner between a parallel connection and a series connection.

In order to avoid repetitions at this point with respect to further advantages of the solid-state cell in accordance with the invention, reference is made to the description of the advantageous embodiment of the method in accordance with the invention and reference is made in full thereto.

### BRIEF DESCRIPTION OF THE DRAWINGS

Further features that improve the invention are disclosed in the description hereinunder of exemplary embodiments of the invention that are illustrated schematically in the figures. All features and/or advantages including structural details, spatial arrangements and method steps disclosed in the claims, the description or the drawings can be essential to the invention both individually and also in the most different combinations. It is to be noted that the figures are only of a descriptive nature and are not intended to limit the invention in any form. In the drawings:

FIG. 1 illustrates a schematic view of a cell layer when viewing the plane of symmetry from above, said cell layer being embodied so as to produce a solid-state cell according to the method in accordance with the invention,

FIG. 2A illustrates schematically a perspective view of multiple cell layers shown in FIG. 1 that are stacked one above the other to form a layer stack, wherein the cell layers are connected in series,

FIG. 2B illustrates schematically a perspective view of multiple cell layers shown in FIG. 1 that are stacked one above the other to form a layer stack, wherein the cell layers are connected in parallel,

FIG. 3 illustrates four cell layers that are connected in series in one plane,

FIG. 4 illustrates four cell layers that are connected in one plane, wherein two cell layers are connected in series and two cell layers are connected in parallel,

FIG. 5 illustrates the connection circuit relating to the cell layers that are connected in FIG. 4,

FIG. 6 illustrates a schematic lateral view of a layer stack that is formed from multiple cell layers that are connected in planes, as illustrated in FIG. 4,

FIG. 7 illustrates a view from above of the layer stack shown in FIG. 6,

FIG. 8 illustrates a view from above of a cell layer that is embodied in a double-symmetrical manner; and

FIG. 9 illustrates a perspective view of a layer stack, wherein the cell layers are rotated in layers by 90° about the axis of symmetry that extends in an orthogonal manner through the plane of symmetry.

Like parts in the different figures are always provided with the identical reference numerals and for this reason are generally only described once.

### DETAILED DESCRIPTION

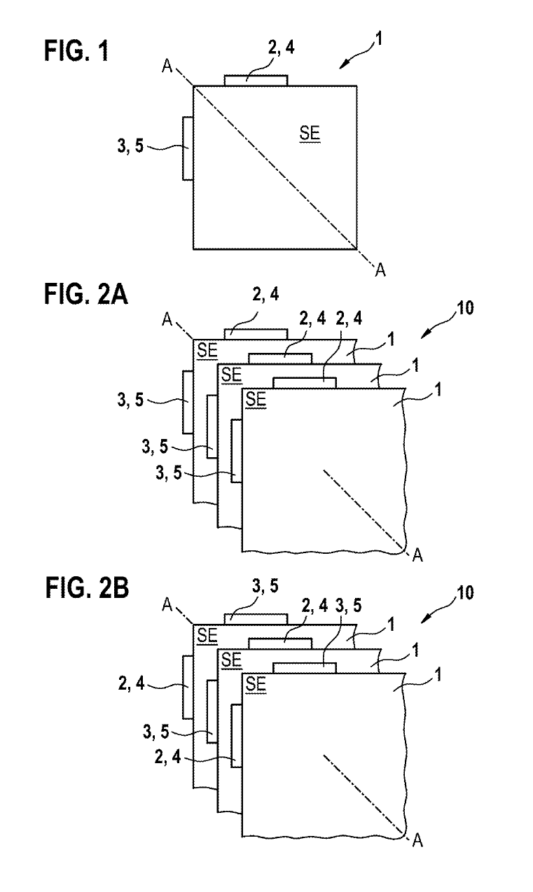

FIG. 1 illustrates a schematic view of a cell layer 1 when viewing the plane of symmetry SE from above, wherein the cell layer is embodied so as to produce a solid-state cell according to the method in accordance with the invention. The cell layer 1 comprises a first conductive layer 2 and a second conductive layer 3. The first conductive layer 2 is separated from the second conductive layer 3 at least by means of a separating layer (not illustrated here). The first conductive layer 2 is advantageously the cathode conductive layer that is preferably produced from an aluminum sheet. The second conductive layer 3 is advantageously the anode conductive layer, the material of which is embodied from a copper or nickel sheet material. The first conductive layer 2, namely in this case advantageously the aluminum sheet, is embodied in the form of a contact lug so as to form a current collector 4, the current collector 5 that in addition is embodied from the second conductive layer 3 in the form of a contact lug is arranged in a symmetrical manner with respect to the axis of symmetry AA that extends through the plane of symmetry SE. The current collectors 4 and 5 are guided as illustrated over and beyond the plane of symmetry SE, in the illustration on the upper side and on the left hand side, out of the cell layer 1. The format of the cell layer 1 in this case is square. The format of the cell layer 1 can however also be embodied in a circular, triangular or any other shape, wherein the plane of symmetry SE is embodied in a symmetrical manner with respect to the axis of symmetry AA. The cell layer 1 illustrated in FIG. 1 renders it possible to produce a solid-state cell with one only cell layer 1. However, it is of advantage to connect to one another the cell layer 1 to further cell layers 1 so as to produce a solid-state cell.

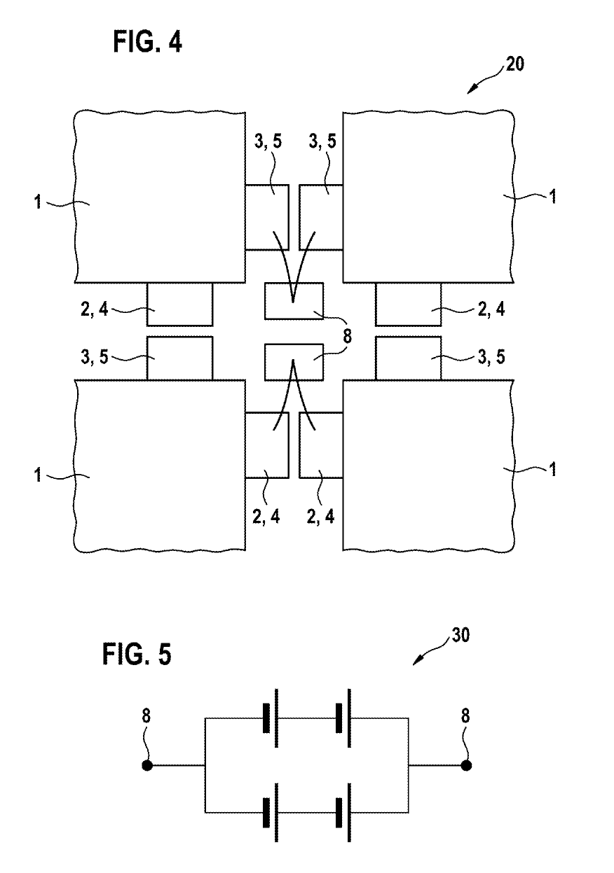

FIGS. 2A and 2B illustrate schematically a perspective view of multiple cell layers 1 that are stacked one above the other and are connected one to the other to form a layer stack 10. The axis of symmetry AA lies, as illustrated in the FIGS. 2A and 2B in an orthogonal manner with respect to the planes of symmetry SE of the cell layers 1. In FIG. 2A, the current collectors 4 that are formed from the first conductive layer 2 are arranged on the upper sides of the cell layers 1. The current collectors 5 that are embodied from the second conductive layer 3 are arranged on the left sides of the cell layers 1. If the current collectors 4 that are formed from the first conductive layer 2 are to be connected by way of a further current collector 8 as illustrated in FIG. 4, and if the current collectors 5 that are formed from the second conductive layer 3 are connected to one another by way of a further current collector 8, the cell layers 1 are connected in parallel to one another in a parallel connection. If the current collectors 4 that are embodied from the first conductive layer 2 are interchanged with current collectors 5 that are formed from the second conductive layer 3 on at least the upper side of the cell layers 1 and on at least the left side of the cell layers 1, as illustrated in FIG. 2B, and if these are connected to a current collector 8 that is lying on the upper side and to a current collector 8 that is lying on the left side, the cell layers are connected to one another in series in a series connection. This arrangement of the cell layers 1 for connecting in a series connection in the layer stack 10 is performed in an advantageous manner by means of rotating the cell layers 1 in an alternating manner about the axis of symmetry AA. In order to connect the current collectors 4 and 5 that are formed as contact lugs from the first conductive layer 2 and the second conductive layer 3 to the further current collectors 8, said current collectors are bonded to the further current collector 8 by means of an ultrasound welding method.

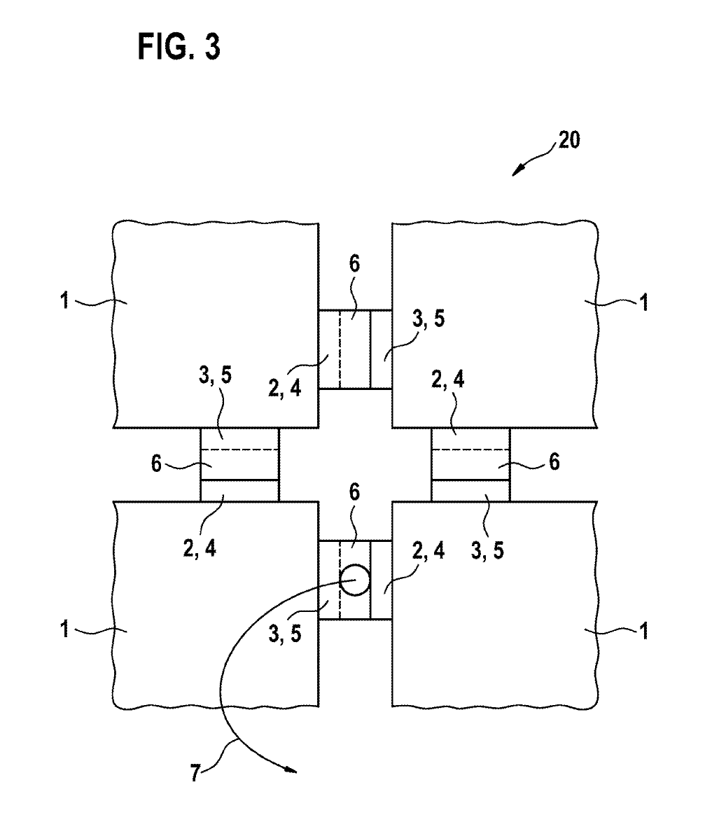

FIG. 3 illustrates in a view from above four cell layers 1 that are connected to one another in series in one plane. In the present case, the cell layers 1 are connected to one another in series, wherein the current collector 5 that is embodied as a contact lug from the second conductive layer 3 is aligned with respect to the current collector 4, which is embodied as a contact lug from the second conductive layer, and is connected thereto in an electrical manner. The electrical connection of the two current collectors 4 and 5 is provided in the present case by means of an overlap 6 that connects the current collectors 4 and 5 to one another in an electrical manner. In general, it is possible to produce a layer step 7 that in the present case is provided at the overlap 6 between the two lower cell layers 1 in FIG. 3, at all contact sites, in other words in each case in the region of the overlap 6 between two cell layers 1 into the next plane. It is also possible to produce an external connection, by way of example to a consumer, in lieu of the layer step 7 at the contact sites.

FIG. 4 illustrates four cell layers 1 that are connected in one plane, wherein two cell layers 1 are connected in series and two cell layers 1 are connected in parallel. In the present case, the two left cell layers 1 are connected to the two right cell layers 1 in a parallel connection, and the left upper cell layer 1 is connected in series to the lower cell layer 1. The upper right cell layer 1 is connected, as illustrated, in series to the lower right cell layer 1. The installation space that is embodied centrally between the cell layers 1 is used in the present case for arranging the current collector 8. The upper current collector 8 is connected to the upper cell layers 1, namely to the current collector 5 that is embodied from the second conductive layer 3. The lower current collector 8 is connected to the current collector 4 that is embodied from the first conductive layer 2.

FIG. 5 illustrates the connection circuit of the cell layers 1 shown in FIG. 4 that are connected in series and parallel to one another.

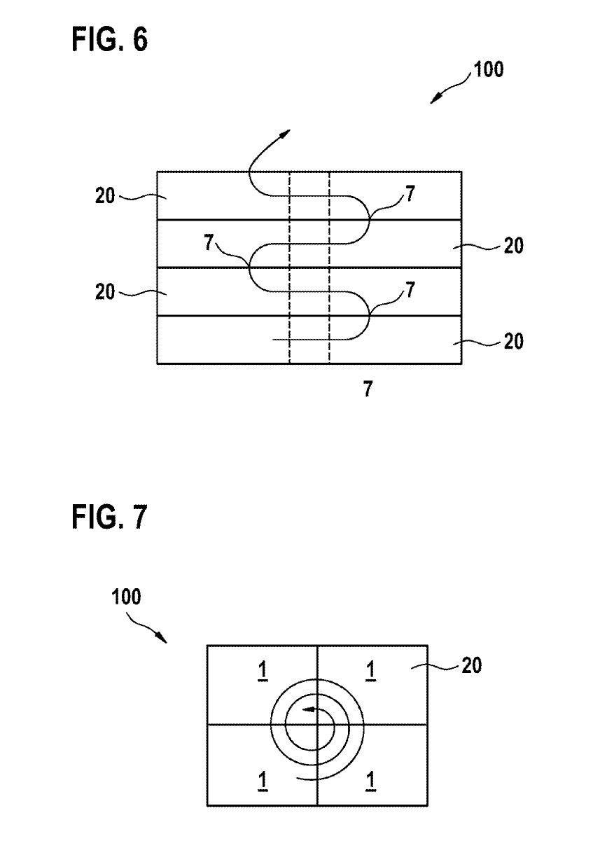

FIG. 6 illustrates a cell layer plane stack 100 that is embodied from multiple cell layers 1 that are connected to one another in a cell layer plane 20, as illustrated in FIG. 4. Multiple cell layer planes 20 are stacked one above the other in the cell layer plane stack 100 and connected to one another. By virtue of connecting the cell layers 1 in an alternating manner, namely providing the connection in series or in parallel, a screw-shaped connection of the cell layer planes 20 that are connected to one another by way of the layer step 7 is produced.

FIG. 7 illustrates in a view from above the cell layer plane stack 100 shown in FIG. 6 so as to better illustrate the screw-shaped connection of the cell layer planes 20 that are connected to one another by way of the layer step 7. As has also been described above in FIG. 4 for the cell layer plane 20, four cell layers 1 are connected to one another in one cell layer plane 20. By virtue of changing the connection of the cell layers 1, namely changing between a series connection and a parallel connection, and by virtue of connecting the cell layer planes 20 by way of the layer step 7 to a further cell layer plane 20, a screw-shaped connection of the cell layers 1 and/or of the cell layer planes in the cell layer plant stack 100 is produced. Naturally, other connection variants are also feasible, whereby overall different connection variants of the cell layer planes 20 and/or of the cell layers 1 within the cell layer plane stack 100 or within the layer stack 10 can be implemented in an advantageous and flexible manner. The inventive connection of multiple cell layer planes 20, which are embodied in one plane by means of cell layers 1 that are connected to one another, and wherein the cell layer planes 20 are connected to one another by way of the layer step 7 to form a cell layer plane stack 100, has the advantage that the large volume expansion or volume shrinkage as the solid-state cell is charged or discharged has only a small influence on the loading of the current collector 4 and 5 that is embodied from the first conductive layer 2 and from the second conductive layer 3.

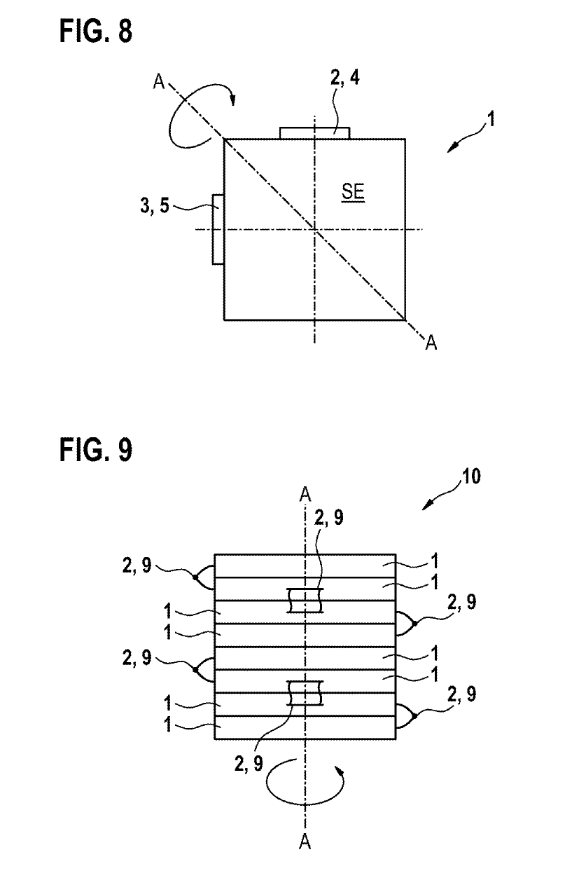

FIG. 8 illustrates a particularly advantageous variant of a cell layer plane 1 that is embodied so as to produce a solid-state cell according to the method in accordance with the invention. In so doing, as illustrated in FIG. 8, not only is the plane of symmetry SE symmetrical in a symmetrical manner with respect to the axis of symmetry AA that extends through the plane of symmetry SE but also the current collectors 4 and 5 that are embodied form the first conductive layer 2 and the second conductive layer 3 are guided in a symmetrical manner, in the present case to the upper side and to the left side of the cell layer, in other words centrally on the upper side and on the left side, over and beyond the plane of symmetry SE out of the cell layer 1. It is not only possible by means of this arrangement to mirror the cell layer 1 by way of the axis of symmetry AA but it is also possible to rotate the cell layer 1 about the axis of symmetry AA. This results in an even more flexible option of connecting the cell layer 1 to other cell layers 1 in a layer stack 10 or in a cell layer plane 20. As already illustrated in FIGS. 2A and 2B, it is possible within a cell layer stack 10 by rotating the cell layer 1, in this case advantageously by 90°, about the axis of symmetry AA that is arranged in an orthogonal manner with respect to the plane of symmetry SE, to connect in series the cell layers 1 that form the cell layer stack 10. By virtue of the mirroring arrangement, in other words a rotation by way of the axis of symmetry AA, the connection between the cell layers 1 can be changed between a series connection and a parallel connection. This is possible both in the cell layer plane 20 and also within a cell layer stack 10 or within a cell layer plane stack 100.

Finally, FIG. 9 illustrates a side view of a cell layer stack 10 that is formed from multiple cell layers 1 that are connected to one another. The first conductive layer 2 is moved as a continuous sheet from one cell layer 1 to the next cell layer 1 and forms deflections 9 between the cell layers 1. The deflections 9 are used in an advantageous manner as current collectors so as to provide a contact to the outside or to connect the layer stack 10 to a further layer stack 10 within a solid-state cell. In order to simplify the accessibility to these connection sites, the cell layers 1 within the cell layer stack 10 are further rotated in layers by 90° about the axis of symmetry AA that lies in an orthogonal manner with respect to the plane of symmetry SE.

1. A method for producing a solid-state cell, comprising at least one cell layer (1) having a first conductive layer (2) and a second conductive layer (3) and at least one separating layer, wherein in each case the first conductive layer (2) and the second conductive layer (3) are connected to a current collector (4, 5) in an electric manner and/or a current collector (4, 5) is embodied in each case from the first conductive layer (2) and/or from the second conductive layer (3), wherein the cell layer (1) comprises a plane of symmetry (SE) that has an axis of symmetry (AA), the method comprising
constructing the plane of symmetry (SE) in a symmetrical manner with respect to the axis of symmetry (AA),
arranging the current collectors (4, 5) in a symmetrical manner with respect to the axis of symmetry (AA), and
guiding the current collectors over and beyond the plane of symmetry (SE) on at least one side out of the cell layer (1).

2. The method as claimed in claim 1, characterized in that a current collector (4,5) is guided on one side of the cell layer (1) and the other current collector (5, 4) is guided on another side of the cell layer (1) out of the cell layer (1).

3. The method as claimed in claim 1, characterized in that the current collectors (4, 5) are arranged in a symmetrical manner with respect to the sides of the cell layer (1) and are guided out of the cell layer (1).

4. The method as claimed in claim 1, characterized in that at least two cell layers (1) are stacked to form a layer stack (10), wherein the two cell layers (1) are arranged with respect to one another in such a manner that at least one plane of symmetry (SE) is formed.

5. The method as claimed in claim 1, characterized in that at least one cell layer (1) is rotated with respect to another cell layer (1) about the axis of symmetry (AA) that extends centrally through the plane of symmetry (SE) and lies in an orthogonal manner with respect to the plane of symmetry (SE), as consequence of which a series connection and/or a parallel connection of the cell layers (1) is produced by way of the current collector (4, 5).

6. The method as claimed in claim 1, characterized in that by virtue of the rotation about the axis of symmetry (AA) by at least 90° of one of the cell layers (1), at least the current collector (4) of the first conductive layer (2) of the first cell layer (1) is brought onto the same side and/or at least approximately into a congruent arrangement with at least the current collector (5) of the second conductive layer (3) of the second cell layer (1).

7. The method as claimed in claim 1, characterized in that at least two cell layers (1) are connected to one another in an electrical manner in at least one cell layer plane (20) in series and/or in parallel by way of the current collectors (4, 5), wherein the current collectors (4, 5) are aligned.

8. The method as claimed in claim 1, characterized in that the solid-state cell comprises at least three layer stacks (10) and/or at least three cell layer plane stacks (100), wherein at least one layer stack (10) and/or at least one cell layer plane stack (100) is connected in parallel to form at least two layer stacks (10) that are connected in series and in an electrical manner to one another and/or is connected in parallel to form at least two cell layer plane stacks (100) that are connected in series and in an electrical manner to one another and is connected in an electrical manner to the layer stacks (10) that are connected in series and/or is connected in an electrical manner to the cell layer plane stacks (100) that are connected in series.

9. A solid-state cell comprising at least one cell layer (1), said cell layer having a first conductive layer (2) and a second conductive layer (3) and at least one separating layer, wherein in each case the first conductive layer (2) and the second conductive layer (3) are connected in an electric manner to a current collector (4, 5) and/or in each case a current collector (4, 5) is embodied from the first conductive layer (2) and/or the second conductive layer (3), characterized in that the first conductive layer (2), the second conductive layer (3) and the separating layer are arranged with respect to one another in such a manner that at least one plane of symmetry (SE) is formed that comprises an axis of symmetry (AA), wherein the plane of symmetry (SE) is constructed in a symmetrical manner with respect to the axis of symmetry (AA) and that the current collectors (4, 5) are arranged in a symmetrical manner with respect to the axis of symmetry (AA) and are guided over and beyond the plane of symmetry (SE) on at least one side out of the cell layer (1).

10. The solid-state cell as claimed in claim 9, wherein at least two cell layers (1), at least two layer stacks (10) and/or at least two cell layer plane stacks (100) are connected to one another in an electrical manner by way of the current collectors (4, 5), wherein at least a first current collector (4) is connected in an electrical manner to the first conductive layer (2) of a first cell layer (1), of a first layer stack (10) or of the first cell layer plane stack (100), and wherein at least one second current collector (5) is connected in an electrical manner to the second conductive layer (3) of the first cell layer (1), of the first layer stack (10) or of the first cell layer plane stack (100) and/or the current collectors (4, 5) are formed from the first conductive layer and/or the second conductive layer, and wherein the first current collector (4) is connected in an electrical manner to a first conductive layer (2) or to a second conductive layer (3) of a second cell layer (1), of a second layer stack (10) or of a second cell layer plane stack (100) and that the second current collector (5) is connected in an electric manner to the second conductive layer (3) or to the first conductive layer (2) of the second cell layer (1), of the second layer stack (10) or of the second cell layer plane stack (100).

11. The method as claimed in claim 1, characterized in that a current collector (4,5) is guided on one side of the cell layer (1) and the other current collector (5, 4) is guided on an adjacent side of the cell layer (1) out of the cell layer (1).

12. The method as claimed in claim 1, characterized in that the current collectors (4, 5) are arranged in a symmetrical manner centrally on the sides of the cell layer (1) and are guided out of the cell layer (1).

13. The method as claimed in claim 1, characterized in that at least two cell layers (1) are connected to one another in an electrical manner in at least one cell layer plane (20) in series and/or in parallel by way of the current collectors (4, 5), wherein the current collectors (4, 5) are aligned with respect to one another.
